(19) United States
(12) Patent Application Publication
(10) Pub. No.: US 2021/0394439 A1
(43) Pub. Date: Dec. 23, 2021

(54) TECHNIQUES FOR POWDER TAGGING IN ADDITIVE FABRICATION AND RELATED SYSTEMS AND METHODS

(71) Applicant: Formlabs, Inc., Somerville, MA (US)

(72) Inventors: Andrew M. Goldman, Stow, MA (US); Connor Evans, Somerville, MA (US)

(73) Assignee: Formlabs, Inc., Somerville, MA (US)

(21) Appl. No.: 17/350,007

(22) Filed: Jun. 17, 2021

Related U.S. Application Data
(60) Provisional application No. 63/041,751, filed on Jun. 19, 2020.

(51) Int. Cl. B29C 64/153; B29C 64/393; B29C 64/255; B29C 64/268; B29C 64/277; B29C 64/286; B33Y 10/00; B33Y 30/00

(52) U.S. Cl. CPC B29C 64/153; B29C 64/393; B29C 64/255; B29C 64/268; B33Y 50/02; B29C 64/286; B33Y 10/00; B33Y 30/00; B29C 64/277

(57) ABSTRACT

Techniques are described for tagging source materials for additive fabrication by incorporating a fluorescent and/or phosphorescent taggant into the source material. A light source within an additive fabrication device may direct light onto the source material and a light sensor may detect whether light having appropriate characteristics was produced from the source material through fluorescence and/or phosphorescence. If such light is detected, the additive fabrication device may determine that the source material is from an approved source and thereby has known properties that may be relied upon for fabrication. Otherwise, the additive fabrication device may determine that the source material is from an unapproved source and may take action such as inhibiting fabrication and/or providing a warning to a user.

### CROSS REFERENCE TO RELATED APPLICATIONS

The present application claims the benefit under 35 U.S.C. § 119(e) of U.S. Provisional Patent Application No. 63/041,751, filed Jun. 19, 2020, titled “Techniques for Powder Tagging in Additive Fabrication and Related Systems and Methods,” which is hereby incorporated by reference in its entirety.

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, selective laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as selective laser sintering, or “SLS,” solid objects are created by successively forming thin layers by selectively fusing together powdered material. One illustrative description of selective laser sintering may be found in U.S. Pat. No. 4,863,538, incorporated herein in its entirety by reference.

### SUMMARY

According to some aspects, an additive fabrication device is provided configured to fabricate parts from a source material, the additive fabrication device comprising a light source configured to direct light onto the source material, a light sensor configured to receive light produced from the source material, at least one processor, and at least one computer readable medium comprising instructions that, when executed by the at least one processor control the light source to direct light onto the source material, and detect whether or not a fluorescent and/or phosphorescent taggant is present in the source material based on the light received by the light sensor from the source material.

According to some aspects, a method is provided of operating an additive fabrication device configured to fabricate parts from a source material to detect one or more taggants within the source material, the method comprising controlling a light source to direct light onto source material, detecting light, using a light sensor, produced from the source material, determining, using at least one processor, whether or not a fluorescent and/or phosphorescent taggant is present in the source material based on the light detected by the light sensor from the source material.

According to some aspects, a composition is provided comprising a sinterable powder comprising at least one polymer, and at least one taggant powder that, when light of a first wavelength is incident on the composition, absorbs the light of the first wavelength and emits light of a second wavelength via fluorescence and/or phosphorescence, the second wavelength being different from the first wavelength.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts an illustrative selective laser sintering device, according to some embodiments;

FIG. 2 depicts a schematic view of a light source and light sensor for detecting fluorescence from a source material, according to some embodiments;

FIGS. 3A-3B depict illustrative light spectra that may be used to detect one or more taggants, according to some embodiments;

FIG. 4 depicts an illustrative selective laser sintering device in which a single light source is used to sinter source material and to detect one or more taggants, according to some embodiments;

FIG. 5 is a flowchart of a method of detecting one or more taggants, according to some embodiments; and

FIG. 6 illustrates an example of a computing system environment on which aspects of the invention may be implemented.

### DETAILED DESCRIPTION

Some additive fabrication techniques, such as Selective Laser Sintering (SLS), form objects by fusing fine material, such as one or more powders, together into larger solid masses. This process of fusing fine material together is referred to herein as “sintering” or “consolidation,” and typically occurs by directing sufficient energy (e.g., heat and/or light) to the material to cause consolidation. Some energy sources, such as lasers, allow for direct application of energy onto a small area or volume. Other energy sources, such as heat beds or heat lamps, direct energy into a comparatively broader area or volume of material.

In some additive fabrication systems, the source material is preheated to a temperature that is sufficiently low as to require minimal additional energy exposure to trigger consolidation. For instance, some conventional systems utilize radiative heating elements configured to consistently and uniformly heat the source material to below, but close to, the critical temperature for consolidation. A laser beam or other energy source directed at the material may provide sufficient energy to cause consolidation, thereby allowing controlled consolidation of material at a small scale.

In these systems, consistency of the temperature of the unconsolidated material may be critical to the successful fabrication of parts using the selective sintering process, both over the full area to be exposed by the focused energy source and over an extended time period as additional exposures are completed. In particular, when consolidating the material, the system should preferably maintain the temperature of the material at or above its consolidation temperature for sufficient time for the consolidation process to complete. Additionally, the system should preferably maintain the temperature of the unconsolidated material at as close to a constant temperature as feasible so that the total amount of energy actually delivered to an area of unconsolidated material can be predicted for a given energy exposure amount.

A process of consolidation such as the one described above depends heavily on known properties of the source material. For instance, the material's ability to absorb heat, to consolidate at a predictable temperature, to retain heat over time, etc. are all factors that will determine the success and effectiveness of the consolidation process. In general, however, a user of an additive fabrication device may be free to supply the device with any desired source material, which may lead to poor fabrication performance if the properties of the source material are different than expected by the additive fabrication device.

The inventors have recognized and appreciated techniques for tagging source materials for additive fabrication by incorporating a fluorescent and/or phosphorescent taggant into the source material. A light source within an additive fabrication device may direct light onto the source material and a light sensor may detect whether light having appropriate characteristics was produced from the source material through fluorescence and/or phosphorescence. If light with the appropriate characteristics is detected, the additive fabrication device may determine that the source material is from an approved source and thereby has known properties that may be relied upon for fabrication. Otherwise, the additive fabrication device may determine that the source material is from an unapproved source and may take action such as inhibiting fabrication and/or providing a warning to a user.

In some embodiments, a user may have access to, and may deploy in an additive fabrication device, any of a variety of source materials with different physical properties. Each of these source materials may be tagged by incorporating a different fluorescent and/or phosphorescent taggant into each type of source material. A variety of approved source materials may thereby be identified and distinguished from one another by determining which of the fluorescent and/or phosphorescent taggants are present in the source material.

In some embodiments, a source material may comprise a fluorescent and/or phosphorescent taggant that degrades when heated in a predictable manner that is detectable by the additive fabrication device. That is, the light produced through fluorescence and/or phosphorescence from an unheated sample of the source material may be different from light produced through fluorescence and/or phosphorescence from a sample of the same source material that has been heated. This degradation may be irreversible so that, once heated, the light produced through fluorescence and/or phosphorescence will always be different than the light so produced prior to heating. Since some additive fabrication devices allow source material that was heated but not sintered to be re-used in a subsequent fabrication process, detecting whether or not the source material has been heated may allow the additive fabrication device to distinguish recycled powder from fresh powder. In some cases, the additive fabrication device may determine a fraction of source material that is recycled and take appropriate action if the fraction is too high for effective fabrication (e.g., to inhibit fabrication and/or provide a warning to a user).

Following below are more detailed descriptions of various concepts related to, and embodiments of, techniques for techniques for tagging source materials for additive fabrication by incorporating a fluorescent and/or phosphorescent taggant into the source material. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

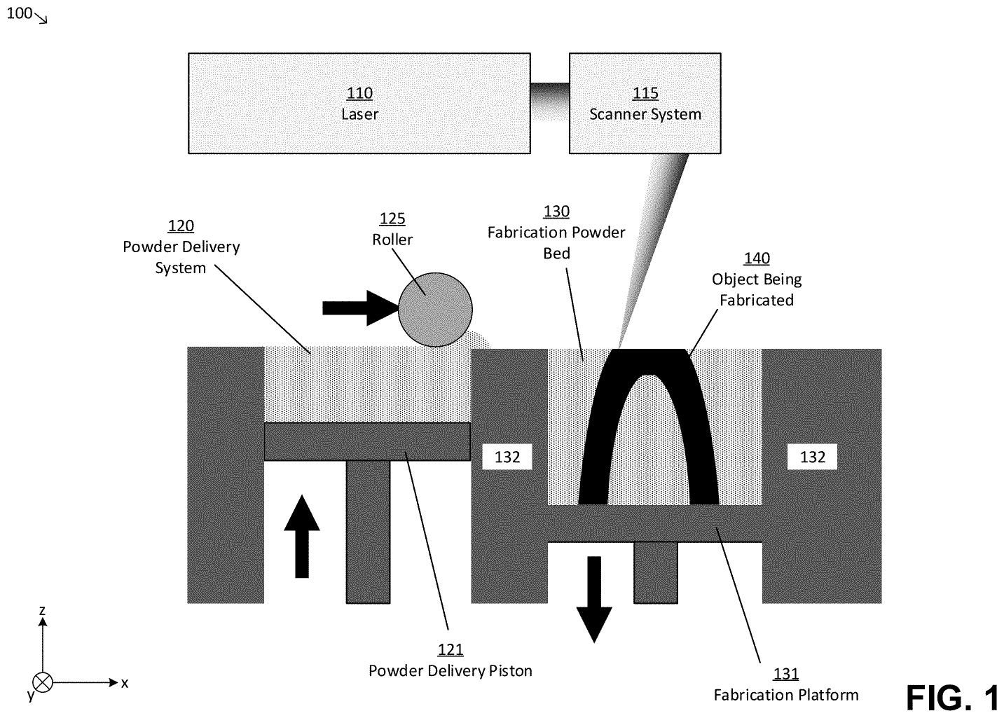

An illustrative system embodying certain aspects of the present application is depicted in FIG. 1. An illustrative selective laser sintering (SLS) additive fabrication device 100 comprises a laser 110 paired with a computer-controlled scanner system 115 disposed to operatively aim the laser 110 at the fabrication bed 130 and move over the area corresponding to a given cross-sectional area of a computer aided design (CAD) model representing a desired part. Suitable scanning systems may include one or more mechanical gantries, linear scanning devices using polygonal mirrors, and/or galvanometer-based scanning devices.

In the example of FIG. 1, the material in the fabrication bed 130 is selectively heated by the laser in a manner that causes the powder material particles to fuse (sometimes also referred to as “sintering” or “consolidating”) such that a new layer of the object 140 is formed. According to some embodiments, suitable powdered materials may include any of various forms of powdered nylon. Once a layer has been successfully formed, the fabrication platform 131 may be lowered a predetermined distance by a motion system (not pictured in FIG. 1). Once the fabrication platform 131 has been lowered, the material deposition mechanism 125 may be moved across a powder delivery system 120 and onto the fabrication bed 130, spreading a fresh layer of material across the fabrication bed 130 to be consolidated as described above. Mechanisms configured to apply a consistent layer of material onto the fabrication bed may include the use of wipers, rollers, blades, and/or other levelling mechanisms for moving material from a source of fresh material to a target location. Additional powder may be supplied from the powder delivery system 120 by moving the powder delivery piston 121 upwards.

Since material in the powder bed 130 is typically only consolidated in certain locations by the laser, some material will generally remain within the bed in an unconsolidated state. This unconsolidated material is commonly known in the art as the part cake. In some embodiments, the part cake may be used to physically support features such as overhangs and thin walls during the formation process, allowing for SLS systems to avoid the use of temporary mechanical support structures, such as may be used in other additive manufacturing techniques such as stereolithography. In addition, this may further allow parts with more complicated geometries, such as moveable joints or other isolated features, to be printed with interlocking but unconnected components.

The above-described process of producing a fresh layer of powder and consolidating material using the laser repeats to form an object layer-by-layer until the entire object has been fabricated. Once the object has been fully formed, the object and the part cake may be cooled at a controlled rate so as to limit issues that may arise with fast cooling, such as warping or other distortion due to variable rate cooling. The object and part cake may be cooled while within the selective laser sintering apparatus, or removed from the apparatus after fabrication to continue cooling. Once fully cooled, the object can be separated from the part cake by a variety of methods. The unused material in the part cake may optionally be recycled for use in subsequent prints.

In the example of FIG. 1, powder in the uppermost layer of the powder bed 130 is maintained at an elevated temperature, low enough to minimize thermal degradation, but high enough to require minimal additional energy exposure to trigger consolidation. Energy from the laser 110 is then applied to selected areas to cause consolidation.

While the illustrative SLS device of FIG. 1 includes a laser as a source of directed energy, it will be appreciated that other SLS devices may rely on other sources of energy to cause consolidation of material. For instance, some SLS devices may utilize a two-dimensional array of independent energy sources, such as infra-red LEDs, and turn on selected ones of the LEDs to direct energy to selected regions of a powder bed. Other SLS devices may heat a portion of the powder bed while applying additional energy to selected regions of the powder bed and thereby cause consolidation.

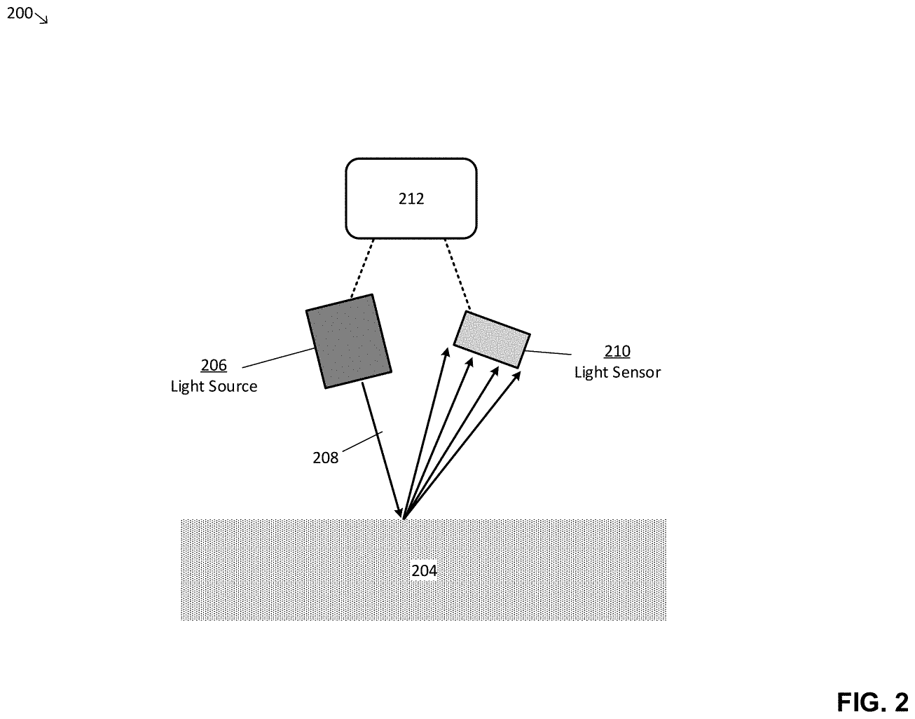

FIG. 2 depicts a schematic view of a light source and light sensor for detecting fluorescence from a source material, according to some embodiments. In the example of FIG. 2, additive fabrication device 200 comprises a light source 206 configured to direct light onto a source material 204, and a light sensor 210 configured to detect light produced from the source material via fluorescence and/or phosphorescence. Additive fabrication device 200 also includes a controller 212 configured to operate the light source 206, the light sensor 210, and to determine whether a particular fluorescent and/or phosphorescent taggant is present in the source material 204 based on light detected by the light sensor 210.

In operation, the light source 206 directs light onto the source material 204, which fluoresces and/or phosphoresces to produce light that is detected by the light sensor 210. The controller 212 is configured to analyze the spectrum of light detected by the light sensor in response to operating the light source 206 to direct said light onto the source material, and to look for a signature with the spectrum that indicates the presence of one or more taggants within the source material.

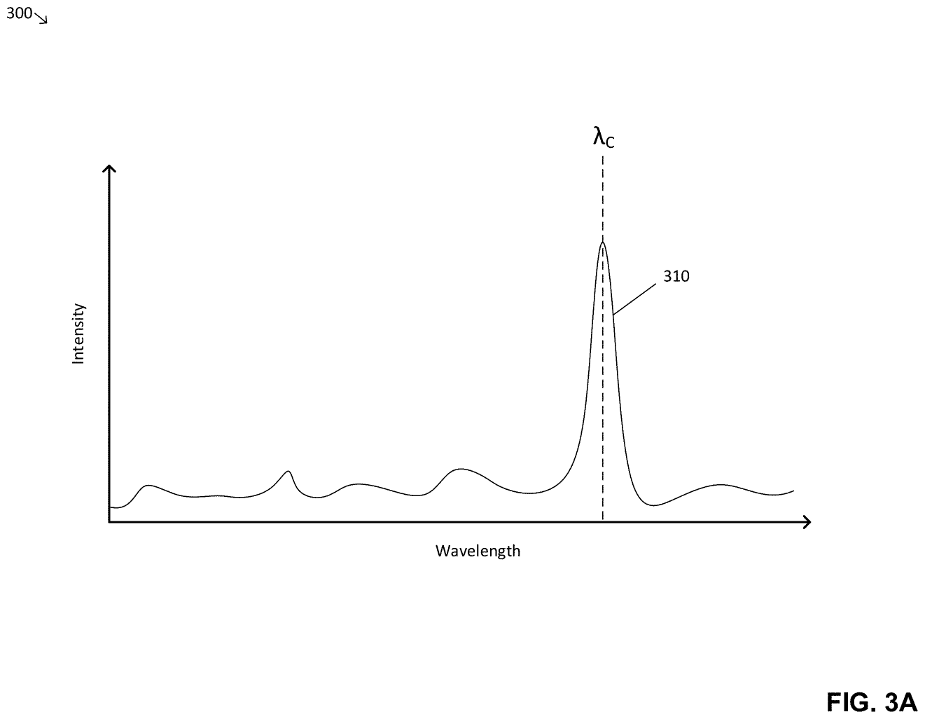

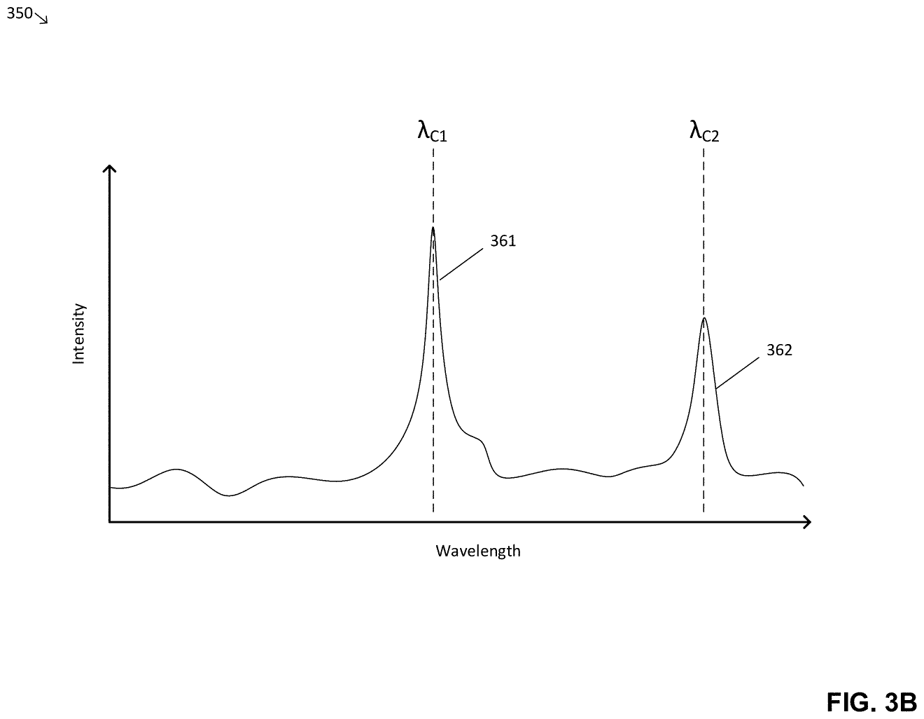

In some embodiments, the presence of a particular taggant may be indicated by a peak in the light intensity spectrum at or centered around a particular characteristic wavelength. For instance, the taggant may be known to fluoresce and/or phosphoresce at a particular wavelength when light from the light source is incident on the taggant, and the controller 212 may be configured to determine whether a sufficiently high intensity of light at this wavelength is present in the spectrum detected by the light sensor 210. For example, as shown in FIG. 3A, a spectrum 300 produced (or otherwise derived from data produced) by the light sensor 210 may indicate a comparatively high intensity of light around a characteristic wavelength Xc. The presence or absence of peak 310 (e.g., above a particular threshold magnitude) may thereby indicate whether or not a particular taggant is present in the source material. The presence or absence of a peak in the light spectrum may be detected by controller 210 in any suitable way, including by detecting whether one or more measurements of light intensity at particular wavelengths is/are above a threshold value.

The above-described detection process may, in some cases, be simulated by a malicious user by directing a suitable light source onto the light sensor 210. As such, a more complex approach to detecting a taggant that is not so easily imitated may be performed by controller 210 as follows. In some embodiments, the presence of a particular taggant or taggants may be indicated by multiple peaks in the light intensity spectrum at or centered around particular characteristic wavelengths. In some cases, the relative intensity of the multiple peaks may be determined. The multiple peaks may be produced by a single taggant or by multiple taggants within the source material. In either case, the spectrum may be sufficiently complex that replicating the spectrum manually may be extremely difficult or impossible.

For instance, as shown in FIG. 3B, a spectrum 350 produced by the light sensor 210 may indicate a comparatively high intensity of light around two characteristic wavelengths λ_{C1} and λ_{C2}. The presence or absence of peaks 361 and 362 may thereby indicate whether or not a particular taggant or particular taggants is/are present in the source material. For instance, a given taggant may absorb light from the light source 206 and may fluoresce and/or phosphoresce at the wavelengths λ_{C1} and λ_{C2}. Alternatively, a first taggant may absorb light from the light source 206 and may fluoresce and/or phosphoresce at the wavelength λ_{C1}, and a second taggant may absorb light from the light source 206 and may fluoresce and/or phosphoresce at the wavelength λ_{C2}. In either case, the two peaks 361 and 362 are indicative of a particular source material being present, and the controller 212 may be configured to consider the source material to be approved only when both peaks are present in the spectrum. As noted above, identification of the peaks may comprise determining their relative intensity in addition to their presence at the characteristic wavelengths. This determination may further increase the difficulty of manipulating the light sensor to fake the signal from the source material. That is, the controller 212 may be configured to consider the source material to be approved only when both peaks are present in the spectrum and have relative amplitudes within a particular range.

Returning to FIG. 2, according to some embodiments, light source 206 may include a scanning or pixelated light source, a laser (which may be, for instance, steered with one or more galvanometers and/or a rotating polygonal mirror), a digital light processing (DLP) device, a liquid-crystal display (LCD), a liquid crystal on silicon (LCoS) display, a light emitting diode (LED), an LED array, a scanned LED array, or combinations thereof. Moreover, additional optical components may be arranged in the path of light emitted by the light source 206 so as to direct light toward a desired position on the optical window, such as, but not limited to, one or more lenses, mirrors, filters, galvanometers, or combinations thereof. In some embodiments, the light source 206 may be a light source that is activated and no further control is applied to the light from the light source. For instance, the light source 206 may be one or more LEDs that are turned on and left on irrespective of whether the light sensor is detecting light or not.

According to some embodiments, light source 206 may be configured to produce light within any suitable range of wavelengths. For instance, light source 206 may be configured to emit visible light and infrared light, infrared light only, or visible light only. The range of wavelengths over which light source 206 is configured to emit light may be dictated by the process by which the light source produces light and/or by including one or more filters between the light source and the source material 204. In some embodiments, the light source 206 is configured to produce near infrared light. In some embodiments, the light source 206 may comprise a laser configured to produce an infrared beam of light, including but not limited to near infrared light.

According to some embodiments, light source 206 may be configured to sinter source material 204 in addition to being configured to produce fluorescence and/or phosphorescence in the source material 204 as described above. For instance, in SLS device 100 shown in FIG. 1, the light source 206 may be the laser 110 and may be operated to produce fluorescence and/or phosphorescence as well as sinter the source material as discussed in relation to FIG. 1. In some embodiments in which the light source 206 is configured to sinter the source material, the light source may be operable in different modes while sintering or producing light to produce fluorescence and/or phosphorescence in the source material. For instance, the light source may be operated at a different power and/or over a different frequency spectrum when operable in each of the two modes.

In other embodiments, the light source 206 may represent a different and distinct light source from any light sources that may be used to cause sintering of the source material.

According to some embodiments, light sensor 210 may include a camera, a photodiode, a light dependent resistor (LDR), a phototransistor, a photomultiplier tube (PMT), an active-pixel sensor (APS), or combinations therefore. In some cases, the light sensor 110 may comprise multiple individual sensor elements; for example, the light sensor 110 may comprise an array of photodiodes. Light sensor 210 may be configured to detect light within any suitable range of wavelengths; for instance, light sensor 210 may be configured to detect visible light and infrared light, infrared light only, or visible light only. The range of wavelengths over which light sensor 210 is configured to detect light may be dictated by the process by which the light sensor detects light and/or by including one or more filters between the light sensor and the source material 204. In some embodiments, a characteristic wavelength of a taggant detected by the light sensor 210 may be a wavelength of visible light.

According to some embodiments, light source 206 produces light of a first wavelength, whereas the controller is configured to detect whether or not a particular taggant (or plurality of taggants) is present in the source material by determining whether light of a particular characteristic frequency or frequencies was detected by the light sensor 210, and the characteristic frequency or frequencies are different from the first wavelength. That is, the light source may produce light at a different wavelength than is considered when detecting the taggant(s).

According to some embodiments, source material 204 may comprise any number of taggants, which may be liquid and/or solid materials that are mixed with the sinterable powder of the source material. In some embodiments, a taggant may be, or may comprise, one or more inorganic oxide powders, such as sodium yttrium fluoride (F₄NaY); organic compounds (e.g. 2,3-dimethyl-2,3-dinitrobutane (DMNB)); organic nanostructures (e.g. graphite, graphene, carbon nanotubes, single wall carbon nanotubes, multi wall carbon nanotubes); metals (e.g. colloidal silver); metal oxides (e.g. titanium oxide, yttrium oxide), ceramics (e.g. doped alumina), polymers (e.g. poly(3,4-ethylenedioxythiophene)/poly(styrene sulfonate) (PEDOT/PSS)); naturally occurring compounds (e.g. proteins); or combinations thereof. Moreover, the taggant may be, or may comprise, one or more materials such as the above examples arranged in nanomaterials (e.g. quantum dots), micromaterials (e.g. powders, pigments), bulk materials (e.g. fibers, filaments, plastics), or any other physical structure. In some embodiments, the taggant may be embedded within a powder in the source material. In some embodiments, the taggant may encapsulate at least some powder within the source material.

In the example of FIG. 2, the source material 204 is arranged in a build region of the additive fabrication device during detection, but this is not a requirement as the techniques described herein are not so limited. In some embodiments, the source material 204 may instead be arranged within a storage container or hopper within the additive fabrication device during detection. As such, the light source 206 and light sensor 210 may be arranged in proximity to such a structure so that taggants may be detected within the source material prior to the source material being deposited in the build region (or indeed before the source material is used at all by the additive fabrication device).

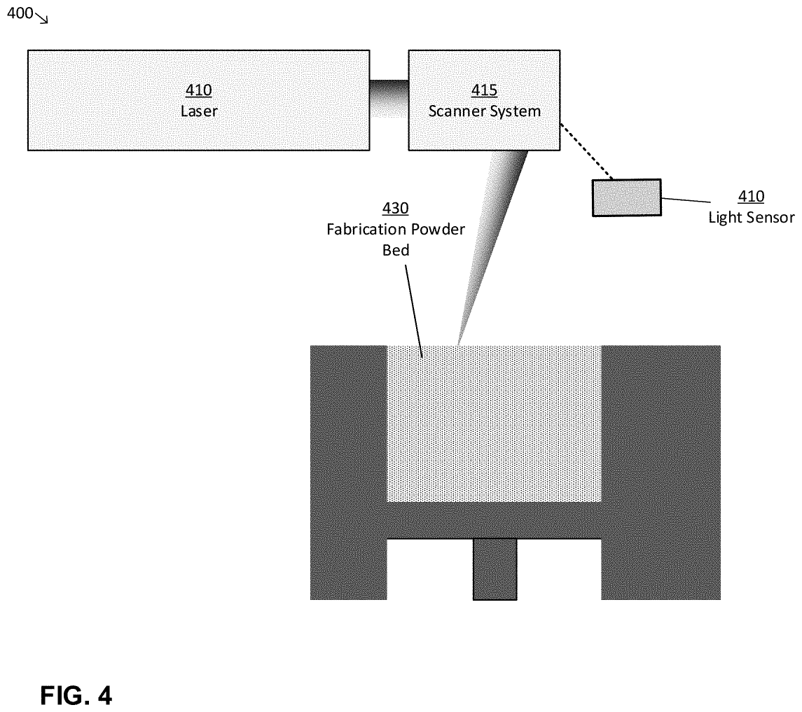

FIG. 4 depicts an illustrative selective laser sintering device in which a single light source is used to sinter source material and also to cause one or more taggants to fluoresce and/or phosphoresce for purposes of detecting one or more taggants, according to some embodiments. As discussed above in relation to FIG. 2, the same light source may be configured to both sinter powder and to cause the powder to fluoresce and/or phosphoresce for purposes of detecting one or more taggants. SLS device 400 represents such a system, in which the laser 410 may be operated to sinter source material within the fabrication powder bed 430 and may also be operated to direct laser light onto the fabrication powder bed and detect light by the light sensor 410 to detect one or more taggants.

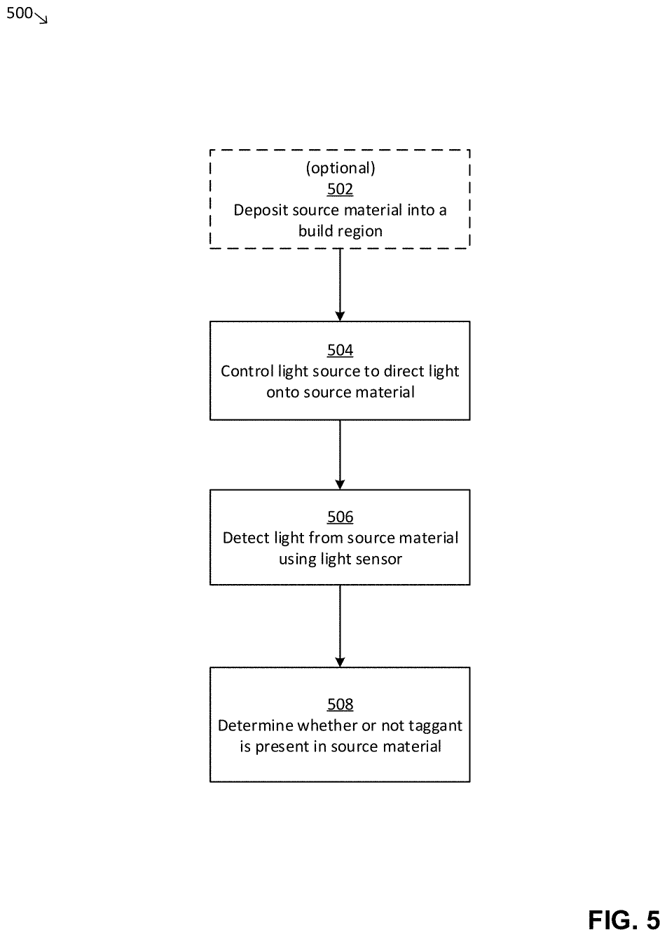

FIG. 5 is a flowchart of a method of detecting one or more taggants, according to some embodiments. At least part of method 500 may be performed by a suitable computing device, examples of which are discussed below. For instance, act 502, 504 and 506 may be performed by a suitable computing device, and optional act 508 may be performed by an additive fabrication device.

In the example of FIG. 5, method 500 optionally begins in act 502 in which a source material is deposited into a build region. As discussed above, in some embodiments an additive fabrication device may be configured to detect taggants within a source material that is arranged within a build region of the additive fabrication device. This is not a requirement, however, as the techniques described herein could be utilized in other locations, such as but not limited to, a storage container or hopper within an additive fabrication device as noted above. As such, act 502 is optional.

In act 504, a light source may be controlled to direct light onto the source material, irrespective of whether it is located within the build region or elsewhere. In act 506, light produced from the source material via fluorescence and/or phosphorescence is detected by a light sensor. In act 508, at least one processor may be operated to determine, based on the light detected in act 506, whether or not a given taggant is present in the source material as discussed above.

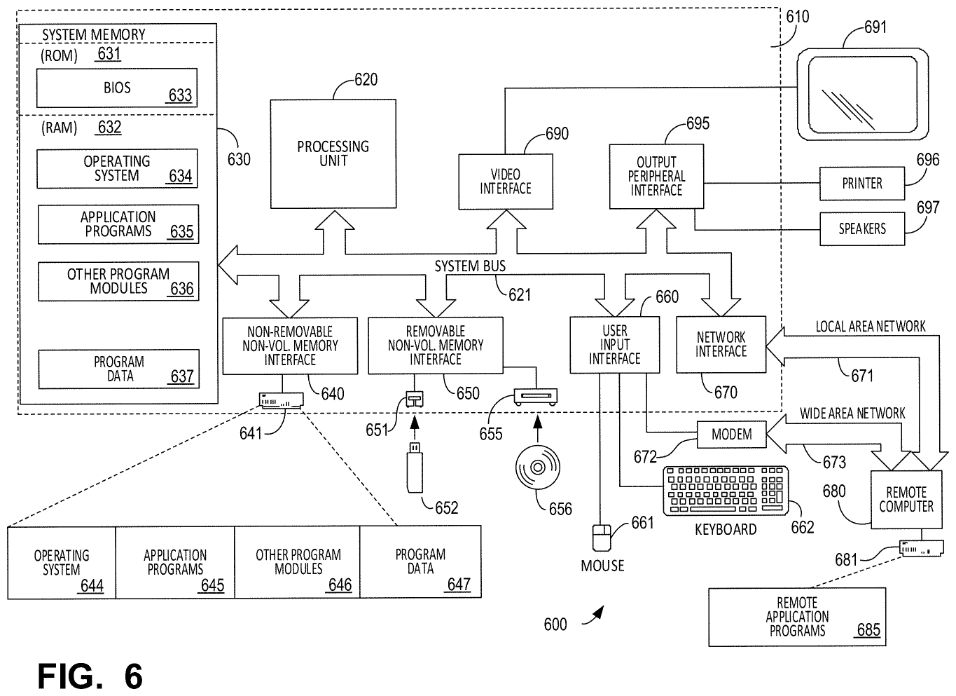

FIG. 6 illustrates an example of a suitable computing system environment 600 on which the technology described herein may be implemented. For example, computing environment 600 may form part of the additive fabrication device 100 shown in FIG. 1. The computing system environment 600 is only one example of a suitable computing environment and is not intended to suggest any limitation as to the scope of use or functionality of the technology described herein. Neither should the computing environment 600 be interpreted as having any dependency or requirement relating to any one or combination of components illustrated in the exemplary operating environment 600.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the technology described herein includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a flash drive 651 that reads from or writes to a removable, nonvolatile memory 652 such as flash memory, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An additive fabrication device configured to fabricate parts from a source material, the additive fabrication device comprising:
a light source configured to direct light onto the source material;
a light sensor configured to receive light produced from the source material;
at least one processor; and
at least one computer readable medium comprising instructions that, when executed by the at least one processor:
control the light source to direct light onto the source material; and
detect whether or not a fluorescent and/or phosphorescent taggant is present in the source material based on the light received by the light sensor from the source material.

2. The additive fabrication device of claim 1, further comprising a build region into which the source material is deposited during fabrication, wherein the light source is configured to direct light onto the source material in the build region, and wherein the light sensor is configured to receive light produced from the source material in the build region.

3. The additive fabrication device of claim 1, further comprising a storage container that holds the source material prior to the source material being moved to a build region of the additive fabrication device, wherein the light source is configured to direct light onto the source material in the storage container, and wherein the light sensor is configured to receive light produced from the source material in the storage container.

4. The additive fabrication device of claim 1, wherein the additive fabrication device is configured to fabricate parts from the source material by directing light other than the light source onto the source material.

5. The additive fabrication device of claim 1, wherein detecting whether or not the fluorescent and/or phosphorescent taggant is present in the source material comprises detecting a characteristic fluorescence and/or phosphorescence wavelength of the light received by the light sensor from the source material.

6. The additive fabrication device of claim 5, wherein the characteristic fluorescence and/or phosphorescence wavelength is not present in the light directed by the light source onto the source material.

7. The additive fabrication device of claim 5, wherein the characteristic fluorescence and/or phosphorescence wavelength is a wavelength of visible light.

8. The additive fabrication device of claim 5,
wherein the characteristic fluorescence and/or phosphorescence wavelength is a first characteristic fluorescence and/or phosphorescence wavelength, and
wherein detecting whether or not the fluorescent and/or phosphorescent taggant is present in the source material further comprises detecting a second characteristic fluorescence and/or phosphorescence wavelength within the light received by the light sensor from the source material, the first characteristic fluorescence and/or phosphorescence wavelength being different from the second characteristic fluorescence and/or phosphorescence wavelength.

9. The additive fabrication device of claim 1, wherein the light source is configured to emit only non-visible light.

10. The additive fabrication device of claim 9, wherein the non-visible light is infrared light.

11. The additive fabrication device of claim 10, wherein the non-visible light is near infrared light.

12. The additive fabrication device of claim 1, wherein the light source is a first light source, and wherein the additive fabrication device further comprises a second light source configured to direct light onto a build region to sinter source material within the build region.

13. The additive fabrication device of claim 12, wherein the light sensor includes a filter configured to filter out light produced by the second light source.

14. A method of operating an additive fabrication device configured to fabricate parts from a source material to detect one or more taggants within the source material, the method comprising:
controlling a light source to direct light onto source material;
detecting light, using a light sensor, produced from the source material;
determining, using at least one processor, whether or not a fluorescent and/or phosphorescent taggant is present in the source material based on the light detected by the light sensor from the source material.

15. The method of claim 14, wherein the light source directs the light onto the source material in a build region into which the source material is deposited during fabrication, and wherein the light sensor receives light produced from the source material in the build region.

16. The method of claim 14, wherein the light source directs the light onto the source material in a storage container that holds the source material, and wherein the light sensor receives light produced from the source material in the storage container.

17. The method of claim 14, wherein detecting whether or not the fluorescent and/or phosphorescent taggant is present in the source material comprises detecting a characteristic fluorescence and/or phosphorescence wavelength of the light received by the light sensor from the source material.

18. The method of claim 17, wherein the characteristic fluorescence and/or phosphorescence wavelength is not present in the light directed by the light source onto the source material.

19. The method of claim 17, wherein the characteristic fluorescence and/or phosphorescence wavelength is a wavelength of visible light.

20. The method of claim 17,
wherein the characteristic fluorescence and/or phosphorescence wavelength is a first characteristic fluorescence and/or phosphorescence wavelength, and
wherein detecting whether or not the fluorescent and/or phosphorescent taggant is present in the source material further comprises detecting a second characteristic fluorescence and/or phosphorescence wavelength within the light received by the light sensor from the source material, the first characteristic fluorescence and/or phosphorescence wavelength being different from the second characteristic fluorescence and/or phosphorescence wavelength.

21. The method of claim 14, wherein the light source emits only non-visible light.

22. The method of claim 21, wherein the non-visible light is infrared light.

23. The method of claim 22, wherein the non-visible light is near infrared light.
